(19) United States
(12) Patent Application Publication
(10) Pub. No.: US 2026/0195310 A1
(43) Pub. Date: Jul. 9, 2026

(54) STORING VECTORS ASSOCIATED WITH CHUNKS OF FILES IN A VECTOR DATABASE TO USE FOR QUERIES OF THE FILES

(71) Applicant: INTERNATIONAL BUSINESS MACHINES CORPORATION, ARMONK, NY (US)

(72) Inventors: Sasikanth Eda, Vijayawada (IN); Khanh Vi Ngo, Tucson, AZ (US); Yadavendra Yadav, Bangalore (IN); Yu-Cheng Hsu, Tucson, AZ (US); Sandeep Ramesh Patil, Pune (IN)

(21) Appl. No.: 19/011,164

(22) Filed: Jan. 6, 2025

(51) Int. Cl. G06F 16/22; G06F 16/23; G06F 16/2455

(52) U.S. Cl. CPC G06F 16/2237; G06F 16/2358; G06F 16/2455

(57) ABSTRACT

Provided are a computer implemented method, system, and computer program product for storing vectors associated with chunks of files in a vector database to use for queries of the files. A content analyzer processes content within a file to determine content descriptions. A determination is made of chunks at storage locations in the file having the content associated with the determined content descriptions. Embedded vectors are generated representing the content descriptions of the chunks in a vector space. The embedded vectors associated with storage locations of the chunks from which the embedded vectors were generated are stored in a vector database. The vector database includes embedded vectors generated from a plurality of files. The vector database is processed to determine embedded vectors similar to a query embedded vector representing a query. Chunks at the storage locations associated with the determined embedded vectors are returned to the query.

### BACKGROUND OF THE INVENTION

The present invention relates to a computer implemented method, system, and computer program product for storing vectors associated with chunks of files in a vector database to use for queries of the files.

A vector database may store embedding vectors used for similarity searches. A vector similarity search allows users to find vectors closest to a given query vector based on a specific metric of similarity. When two embedding vectors are similar, the original data sources from which the embedding vectors were generated are also similar. A vector similarity search may be used to determine a distance between a query vector, comprising an embedding of a search query, and vectors comprising embeddings of a collection of data in a database.

### SUMMARY

Provided are a computer implemented method, system, and computer program product for storing vectors associated with chunks of files in a vector database to use for queries of the files. A content analyzer processes content within a file to determine content descriptions of the content in the file. A determination is made of chunks at storage locations in the file having the content associated with the determined content descriptions. Embedded vectors are generated representing the content descriptions of the chunks in a vector space. The embedded vectors associated with the storage locations of the chunks from which the embedded vectors were generated are stored in a vector database. The vector database includes embedded vectors generated from a plurality of files. The vector database is processed to determine embedded vectors similar to a query embedded vector representing a query. Chunks at the storage locations associated with the determined embedded vectors are returned to the query.

### BRIEF DESCRIPTION OF THE DRAWINGS

FIG. 1 illustrates an embodiment of a computing environment to allow for distributed searching of vector databases at different storage systems.

FIG. 2 illustrates an embodiment of a chunk vector entry in a vector database having an embedded vector for a chunk of data in a file.

FIG. 3 illustrates an embodiment of operations to index files to generate embedded vectors for chunks of the files to include in the vector database.

FIG. 4 illustrates an embodiment of operations to process a write request to a file and update the chunk vector entries in the vector database affected by the write.

FIG. 5 illustrates an embodiment of operations to generate an embedded query vector from a query search from a user.

FIG. 6 illustrates an embodiment of operations for a query manager to perform a similarity search between an embedded query vector and vectors in the vector database to find chunks of data in files to return to the query.

FIG. 7 illustrates a computing environment in which the components of FIG. 1 may be implemented.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description herein provides examples of embodiments of the invention, and variations and substitutions may be made in other embodiments. Several examples will now be provided to further clarify various embodiments of the present disclosure:

Example 1: A computer implemented method comprising processing, by a content analyzer, content within a file to determine content descriptions of the content in the file. The method further comprises determining chunks at storage locations in the file having the content associated with the determined content descriptions. The method further comprises generating embedded vectors representing the content descriptions of the chunks in a vector space. The method further comprises storing the embedded vectors associated with the storage locations of the chunks from which the embedded vectors were generated in a vector database. The vector database includes embedded vectors generated from a plurality of files. The method further comprises processing the vector database to determine embedded vectors similar to a query embedded vector representing a query. The method further comprises returning, to the query, chunks at the storage locations associated with the determined embedded vectors. Thus, embodiments advantageously allow for the vector database to maintain the storage locations for the embedded vectors to allow for the specific chunks, from which the matching content description of the embedded vector was generated, to be returned to a query. This allows for query results that include just the specific relevant chunks of the file that satisfy the query and not the entire file content.

Example 2: The limitations of any of Examples 1 and 3-8 may optionally include that returning the chunks comprises determining storage locations associated with the determined embedded vectors in the vector database. Chunks of data at the storage locations are read to return to the query. Thus, embodiments advantageously allow for determining the storage locations in the file having the chunks from which content descriptions were generated that are substantially similar to the query. This advantageously allows targeting of returning data read from the particular storage locations having content whose content description is similar to content of the query.

Example 3: The limitations of any of Examples 1, 2 and 4-8 may optionally include that the storage locations associated with the chunks comprise ranges of logical block addresses (LBAs) in a storage system. Thus, embodiments advantageously allow for accessing relevant chunks for the query from LBA locations in the storage system. This provides fine grained control of returning content that is relevant to the query at the block level of storage.

Example 4: The limitations of any of Examples 1-3 and 5-8 may optionally include the method processing a write including write data to write to a target file. The method further comprises writing the write data to the target file. The method further comprises determining updated chunks in the target file including the write data. The method further comprises processing, by the content analyzer, the updated chunks to generate updated content descriptions of the updated chunks. The method further comprises generating updated embedded vectors representing the updated content descriptions. The method further comprises updating the vector database with the updated embedded vectors for the updated chunks. Thus, embodiments advantageously allow for only generating updated content descriptions for the updated chunks and only updating the updated chunks in the vector database. This improves the processing speed of updating the vector database by only re-calculating the content descriptions for updated chunks and updating the vector database for only updated chunks, instead of for the entire file content.

Example 5: The limitations of any of Examples 1-4 and 6-8 may optionally include that the embedded vectors in the vector database are only updated if an updated embedded vector differs from a stored embedded vector for a chunk in the vector database. Thus, embodiments advantageously allow for only updating the vector database for updated embedded vectors for specific chunks in the file that have changed. The operations to update the vector database are optimized to avoid updating embedded vectors that have not changed since the update to the file.

Example 6: The limitations of any of Examples 1-5, 7, and 8 may optionally include sections of text within the file of variable size. The content descriptions for the chunks comprise topic analysis of text within the chunks. Thus, embodiments advantageously allow for storing embedded vectors for chunks in the file that have specific content descriptions based on a topic analysis of the text within the chunks. This allows for searching for chunks having a content description that matches that of the query. In this way, chunks not having content description matching that of the search query are not returned to the query This ensures query results to only have content specific to the query requirements.

Example 7: The limitations of any of Examples 1-6 and 8 may optionally include that there are a plurality of vector databases having embedded vectors representing chunks of data in files in storage systems distributed over a network. The processing the vector database to determine embedded vectors similar to the query embedded vector representing the query comprises comparing the query embedded vector to embedded vectors in the plurality of vector databases. The comparison is performed to determine embedded vectors in the vector databases for the storage systems that are similar to the query embedded vector. For the determined embedded vectors in the vector databases, the method further comprises determine storage locations in the storage systems associated with the vector databases. The method further comprises fetching the chunks at the determined storage locations in the storage systems distributed across the network to return to the query. Thus, embodiments advantageously allow for the vector database to be extended across storage systems to allow for query searching across the storage systems at different locations to improve the query results by providing results from different sources.

Example 8: The limitations of any of Examples 1-6 and 8 may optionally include that the determined chunks have different content descriptions. A chunk within the file corresponds to a range of storage locations having content resulting in a different content description from content descriptions for adjacent chunks in the file. Thus, embodiments advantageously allow chunks to distinguish from adjacent chunks by having different content descriptions. In this way, each chunk provides a distinct content description to allow for query results to be returned from specific chunks or sections of the file having content relevant to the content of the query.

Example 9 is an apparatus comprising means to perform a method of any of the Examples 1-8.

Example 10 is a machine-readable storage including machine-readable instructions, that when executed, implement a method or realize an apparatus of any of the Examples 1-8.

Example 11: A system comprising one or more processor and one or more computer-readable storage media collectively storing program instructions which, when executed by the processor, are configured to cause the processor to perform a method according to any of Examples 1-8.

Example 12: A computer program product comprising one or more computer readable storage media, and program instructions collectively stored on the one or more computer readable storage media, the program instructions comprising instructions configured to cause one or more processors to perform a method according to any one of Examples 1-8.

Example 13: The limitations of Examples 1 and 4, wherein embodiments advantageously allow for updating of the vector database with updated embedded vectors generated from updated content descriptions for updated chunks in a file including write data from a write. This advantageously ensures the query is processed against updated embedded vectors representing updated content descriptions to provide real time results from updated files in the storage.

Example 14: The limitations of Examples 1 and 7, wherein embodiments advantageously allow a query embedded vector to be processed against multiple vector databases for multiple storage system. This advantageously allows the results to be supplemented from different data sources to allow for retrieval augmented generation when returning results for large language models.

Prior art vectorization processes involve processing data in a file and converting the data into meaningful extracts using machine learning models. The machine learning models then produce context descriptions that may be converted to high dimensional vectors. In a high velocity storage system, data is updated frequently. When a file is updated, a request must be queued to have the machine learning model reprocess the file to update the context descriptions. The context descriptions may change due to the file update. The delays in re-embedding the context descriptions for a file and updating the vector database may result in the vector database having stale data. This in turn may result in query results that are based on such stale data.

Described embodiments provide improvements to computer technology for indexing file data in a vector database by breaking up a file into chunks or sections having different content descriptions of the content. The content description for each chunk of a file may be separately subject to embedding to convert to a vector. The vector database may then store embeddings for individual chunks of a file providing the different content descriptions of the file.

This structure of the indexed files allows for fast, real-time updating of the vector database. With the described embodiments, when a file is updated, the affected indexed chunks of the file are determined and the content description of those updated chunks are generated and then subject to embedding. By only updating the embeddings in the vector database for updated chunks instead of the entire file, the time to update the vector database is greatly reduced to allow for faster real-time updates of the vector database. This in turn allows real-time search results from the vector database to be returned to queries.

Described embodiments allow for incoming content analysis of a file to determine dynamic chunks comprising chunks whose content and possible size has changed. The identified context of a dynamic chunk is embedded as vectors. Additional metadata is provided with the dynamic chunk to indicate the disk block range identifiers/locations of the dynamic chunk in the file. With described embodiments, a search query uses the resulted top ranked results and performs a segmented/partial fetch to read only the dynamic chunks of the result files from multiple sites. Described embodiments further provide for selective re-embedding of chunk data if the context of the extracted chunk is modified. Described embodiments further allow for read-ahead data from multiple sites based on the context of the extracts.

Described embodiments accomplish the above results by analyzing the file content, splitting the file into dynamic chunks based on the identified content variations, and vectorizing the content. The vectorized content is associated with metadata comprise block range identifiers of the dynamic chunk location in the file. Further, each time data in a file changes, re-embedding is only performed with respect to those chunks whose content description has changed, further reducing the amount of content analysis and re-embedding needed to process updates. Further, with described embodiments, re-embedding is only performed if the content description has changed, not just if the content itself has changed. Described embodiments further improve the search results by selectively fetching the top ranked results which may be spread across various sites.

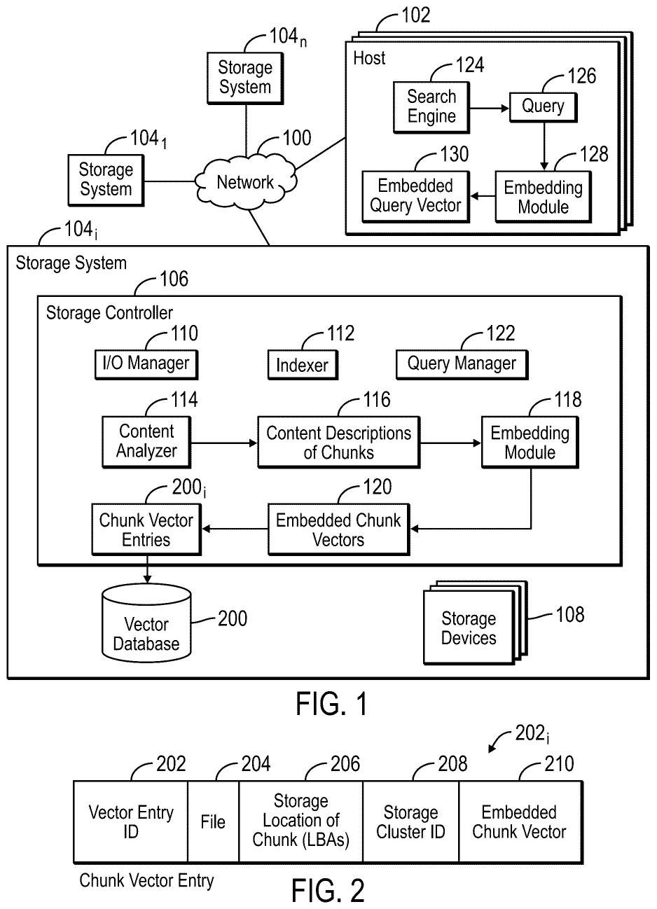

FIG. 1 illustrates an embodiment of a network 100 of hosts 102 and distributed storage systems 104₁ . . . 104ₙ. A storage system 104ᵢ, where i indicates a representative storage system, includes a storage controller 106 and storage devices 108. The storage controller 106 includes an Input/Output (“I/O”) manager 110 to manage read and write requests to data in the storage devices 108. The storage controller 106 also has an indexer 112 to generate chunk vector entries 200; in the vector database 200 having embedded vectors representing content descriptions of chunks of data in the files in the storage devise 108. The indexer 112 may send file data to a content analyzer 114, comprising a machine learning model, that analyzes content in a file to generate content descriptions 116 of chunks of data in a file. The generated content descriptions may comprise subject matter of the content, topics in the content, sentiment of the content, tone of the content, concepts in the content, etc.

The indexer 112 may forward the content descriptions 116 to an embedding module 118 to generate embedded chunk vectors 120 comprising numerical representations of the content descriptions 116 in a vector space. The indexer 112 may generate chunk vector entries 200ᵢ when first processing the files in the storage system 102ᵢ to build the index and when receiving a write request to a file that modifies chunks in the file.

A chunk vector entry 200ᵢ, as shown in FIG. 2, includes, by way of example: a vector entry identifier (ID) 202; a file 204 including the chunk; storage locations 206 in the storage devices of the chunk in the file 204, such as a range of logical block addresses (LBAs); a storage cluster ID 208 of the cluster of storage devices 108 including the file 204; and the embedded chunk vector 210 generated from the chunk in the file.

The storage controller 106 may further include a query manager 122 to process queries from the hosts 102 to locate chunks in the files in the storage system 104ᵢ that are sufficiently similar to the content of the queries. The hosts 102 may each include a search engine 124 to receive search terms from a user, such as a question, or a program. For instance, the search terms may be from a retrieval augmented generation (RAG) component of a large language model (LLM) to gather further information to improve the accuracy of text generated as part of the LLM. An embedding module 128 may generate an embedded query vector 130 from the query terms 126 providing a numerical representation of the query terms 126 in a vector space.

The embedding modules 118, 128 may be implemented as a deep neural network to produce embedded vectors comprising numerical representations of chunks of content in a file, such as text, and query terms. In certain embodiments, the outputted embedded chunk vectors 120 and embedded query vector 130 may have a same dimensionality to allow for comparison of the measurements. The embedding modules 118, 128 may utilize text embedding algorithms such as, but not limited to, Word2vec, Glove, Explicit Semantic Analysis, FastText, etc.

The search engine 124 may transmit the embedded query vector 130 over the network 100 to the storage systems 104ᵢ in the network 100. The query manager 122 may search the vector databases 200 for chunks in the file having embedded chunk vectors 120 similar to the embedded query vector 130. Similarity may be determined by closeness of distance between the embedded vectors in the vector space. For instance, an embedded query vector and embedded chunk vector may be deemed sufficiently similar if their vectors are within a threshold distance in the vector space. The query manager 122 may determine a similarity score between the embedded query vector 130 and the embedded chunk vectors 120. The similarity score may be based on a geographic distance between the embedded query vector 130 and embedded chunk vectors 120. The query manager 122 may determine the spatial measurement in the multi-dimensional vector space using one of a cosine similarity, dot product measurement, a Manhattan distance measurement, a Euclidean distance measurement, etc.

The arrows shown in FIG. 1 between the components and objects in the host 102 and storage controller 106 represent a data flow between the components.

In described embodiments, the search is performed with respect to content comprising text. The content analyzer 114 and embedding modules 118, 128 process text content to produce the embedded vectors 120, 130. In further embodiments, the search content may comprise images, audio, video, etc. In such alternative embodiments, the content analyzer and embedding modules may operate on alternative content types.

In FIG. 1, the host 102 includes an embedding module 128 to convert the query to an embedded query vector 130. In an alternative embodiment, search engine 124 may not include the embedding module 128. Instead, the search engine 124 may transmit the query 126, such as textual search terms, to the storage controller 106. The storage controller may then perform the embedding to convert the query 126 to an embedded query vector 130 to compare with the vectors in the vector database 200.

Generally, program modules, such as the program components 110, 112, 114, 118, 122, 124, 128, among others, may comprise routines, programs, objects, components, logic, data structures, and so on that perform particular tasks or implement particular abstract data types. The program components and hardware devices of the systems 102, 104ᵢ may be implemented in one or more storage systems or computer systems, where if they are implemented in multiple storage systems or computer systems, then the storage systems or computer systems may communicate over a network or a bus.

The program components 110, 112, 114, 118, 122, 124, 128, among others, may be accessed by a processor from memory to execute. Alternatively, some or all of the program components 110, 112, 114, 118, 122, 124, 128, among others, may be implemented in separate hardware devices, such as Application Specific Integrated Circuit (ASIC) hardware devices or a Field Programmable Gate Array (FPGA).

Program components implementing machine learning models, such as program components 114, 118, 128, among others, may be implemented in an Artificial Intelligence (AI) hardware accelerator, such as an FPGA or a graphics processing unit (GPU).

In certain embodiments, program components 114, 118, 128, among others, may use machine learning and deep learning algorithms, such as decision tree learning, XGBoost, Random Forest, association rule learning, neural network, inductive programming logic, support vector machines, Bayesian network, Recurrent Neural Networks (RNN), Feedforward Neural Networks, Convolutional Neural Networks (CNN), Deep Convolutional Neural Networks (DCNNs), Generative Adversarial Network (GAN), etc. For artificial neural network program implementations, the neural network may be trained using backward propagation to adjust weights and biases at nodes in a hidden layer to produce their output based on the received inputs. In backward propagation, biases at nodes in the hidden layer are adjusted accordingly to produce the output, such as classification of a vector indicating presence of malware and ransomware, with specified confidence levels based on the input parameters. The program components 114, 118, 128, among others, may be trained to produce their output from feedback and their output based on the input. Backward propagation may comprise an algorithm for supervised learning of artificial neural networks using gradient descent.

Given an artificial neural network and an error function, the method may use gradient descent to find the parameters (coefficients) for the nodes in a neural network or function that minimizes a cost function measuring the difference or error between actual and predicted values for different parameters. The parameters are continually adjusted during gradient descent to minimize the error.

The functions described as performed by the program components 110, 112, 114, 118, 122, 124, 128, among others, may be implemented as program code in fewer program modules than shown or implemented as program code throughout a greater number of program modules than shown.

The host 102 may comprise a virtual or physical machine. The storage controller 104ᵢ may comprise a storage server, enterprise storage server, etc.

The storage devices 108 may comprise hard disk drives, solid state drives (SSDs), and other types of storage devices. The storage devices 108 may be configured into an array of devices, such as Just a Bunch of Disks (JBOD), Direct Access Storage Device (DASD), Redundant Array of Independent Disks (RAID) array, virtualization device, etc. Further, the storage devices may comprise heterogeneous storage devices from different vendors or from the same vendor.

The network 100 may comprise a Storage Area Network (SAN), a Local Area Network (LAN), a Wide Area Network (WAN), the Internet, and Intranet, etc.

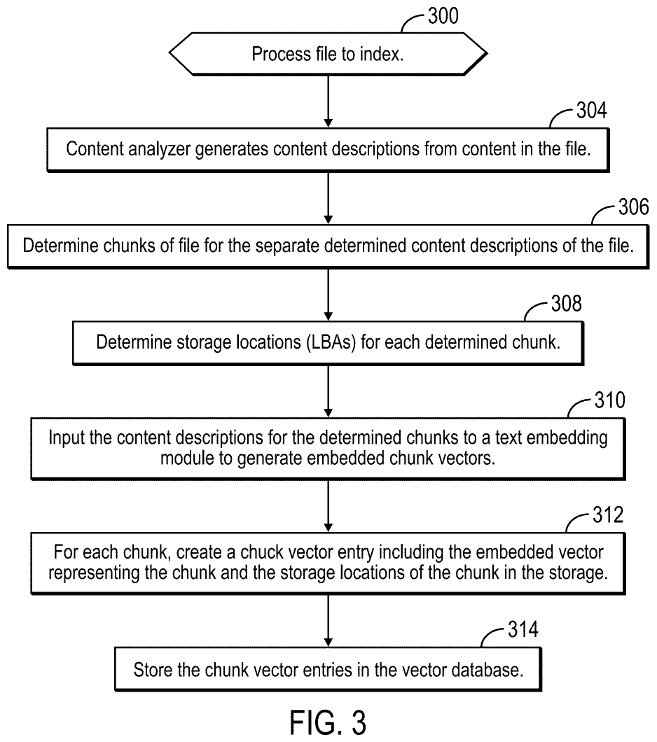

FIG. 3 illustrates an embodiment of operations performed by an indexer, content analyzer, and embedding module to generate chunk vector entries 200ᵢ from chunks of data in files in the storage devices. The operations of FIG. 3 may be performed as part of an initial indexing of files in the storage devices to build the vector database. In certain embodiments, the indexer may comprise the indexer 112, the content analyzer may comprise content analyzer 114, and the embedding module may comprise embedding module 118, as described with respect to FIG. 1.

Upon initiating (at block 300) indexing of a file in the storage devices, the content analyzer generates (at block 304) content descriptions from content in the file. The indexer may determine (at block 306) chunks of the file for the separate determined content descriptions of the file. The chunks may comprise contiguous content in the file from which a content description is determined. Different chunks may have different content descriptions or there may be just one content description for the entire file content. The storage locations, such as logical block addresses (LBAs), are determined (at block 308) for each determined chunk having a separate content description. The content descriptions for the determined chunks are inputted (at block 310) to an embedding module to produce embedded chunk vectors providing numerical representations of the content descriptions in a vector space.

The indexer creates (at block 312) a chunk vector entry (e.g., 200ᵢ) for each determined chunk including the file being indexed, the determined storage locations of the chunk, the cluster ID of the storage devices 108, and the generated embedded chunk vector. The chunk vector entries are stored (at block 314) in the vector database to use for search queries.

With the operations of FIG. 3, if the whole file is composed of a single context, or single content description, then the entire file is treated as a single chunk. If the file contains different content descriptions for different sections of content, then the file is dynamically chunked based on content description differences between chunks and each separate content description will be stored separately. In this way, different files will have a different number of chunks, different sized chunks, and different number of chunk vector entries in the vector database.

The storage locations or block ranges in which chunks are stored may be identified using respective filesystem block administrative commands or by user kernel/user space filtering/administrative commands.

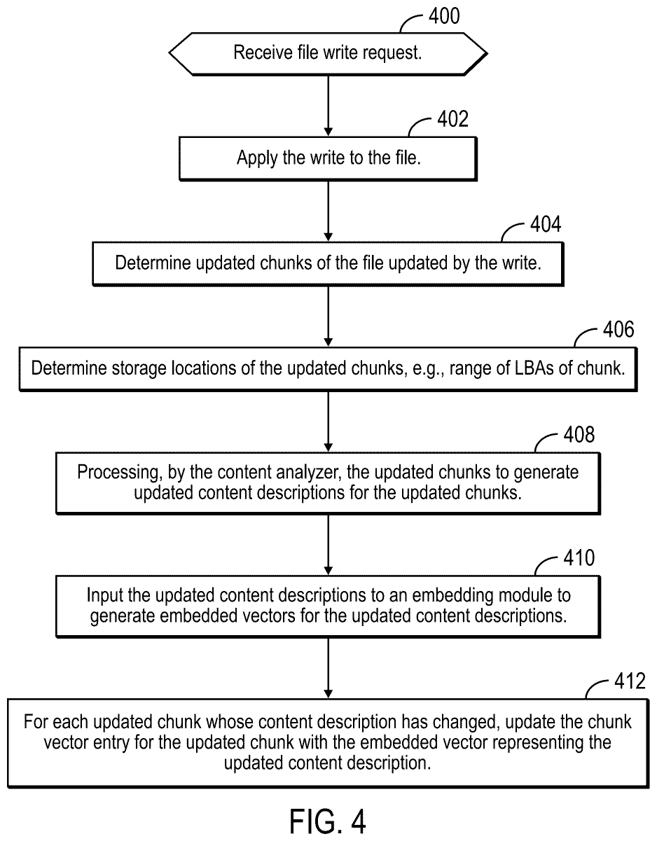

FIG. 4 illustrates an embodiment of operations performed by the indexer, content analyzer, and embedding module to update chunk vector entries from chunks in files updated by a write operation. In certain embodiments, the indexer may comprise the indexer 112, the content analyzer may comprise content analyzer 114, the embedding module may comprise embedding module 118, and the chunk vector entries may comprise entries 200; as described with respect to FIG. 1.

A file write request is received (at block 400). The file write request may be intercepted using Extended Berkley Packet Filter (eBPF) or the already written data block ranges of the context chunk that are identified using the filesystem block commands. The write is applied (at block 402) to the file. The indexer may determine (at block 404) the predefined chunks of the file that were updated from the locations, e.g., LBAs, in the file that were updated. The chunks may be defined in the chunk vector entries. A determination is made (at block 406) of the storage locations of the updated chunks, such as a range of LBAs indicated in the chunk vector entries. The updated chunks are processed (at block 408) by the content analyzer to generate updated content descriptions for the updated chunks. The updated description may comprise the same description or a different content description for the updated chunk. The updated content descriptions are inputted (at block 410) to the text embedding module to generate embedded vectors for the updated content descriptions.

For each updated chunk whose content description has changed, the chunk vector entry for the updated chunk is updated (at block 412) with the embedded vector representing the updated content description and the storage locations of the updated chunk in the file. The indexer may determine that the content description has changed by comparing the vector for the updated content description with the stored embedded vector. With the operations of FIG. 4, if the content description is not modified, then the block range identifiers for the updated chunk are only updated in the metadata associated with the respective vectors, not the embedded vector representing the content description.

With the operations of FIGS. 3 and 4, a file is broken down into chunks having separate content descriptions. The content descriptions provide a contextualization or description of the content of the chunks. The content descriptions are converted to embedded chunk vectors that are stored in a vector database. By updating the content descriptions for only those chunks whose content is changed, the vectorization operations on the file are optimized because only those chunks or sections of the text that are updated are subject to updating. This is an improvement over techniques that process an entire updated file to generate the content descriptions. Further, the content analysis and embedding operations are substantially reduced by only subjecting updated chunks in the file to this machine learning processing, as opposed to the entire file.

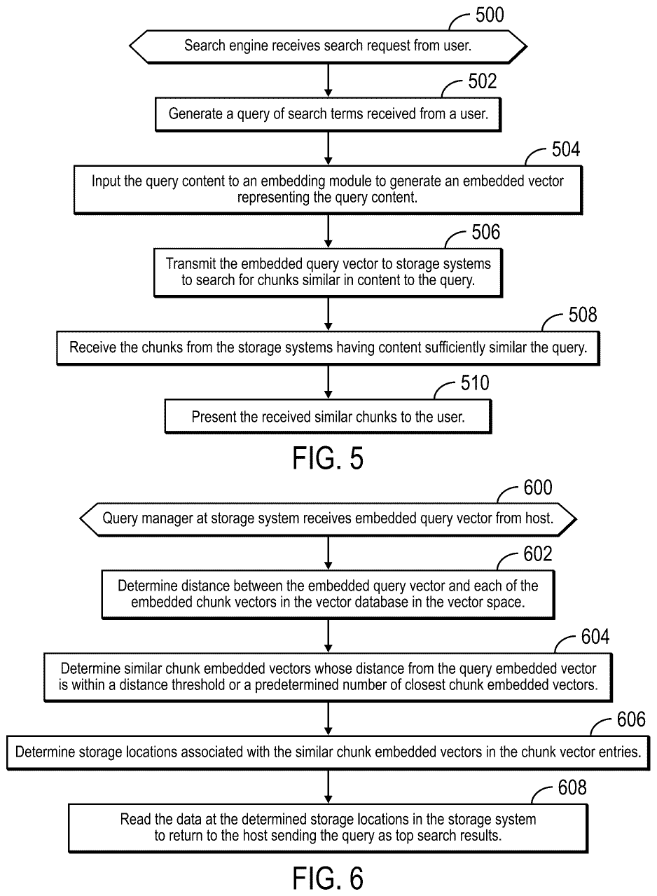

FIG. 5 illustrates an embodiment of operations performed by the search engine and embedding module to produce an embedded query vector. In certain embodiments, the search engine may comprise search engine 124, the embedding module may comprise embedding module 128, the storage devices may comprise the storage devices 108, and the embedded query vector may comprise embedded query vector 130 as described with respect to FIG. 1.

Upon the search engine receiving (at block 500) a search request from the user, the search engine generates (at block 502) a query of search terms or content from the user. The query content is inputted (at block 504) to an embedding module to generate an embedded vector representing the query content. The embedded query vector is transmitted (at block 506) to storage systems in the network to search for chunks having content similar to the content of the query. The search engine receives (at block 508) the chunks from the storage systems having data substantially similar or related to the query content. The search engine presents (at block 510) the received similar chunks to the user.

FIG. 6 illustrates an embodiment of operations performed by the query manager 122 to process an embedded query vector to determine chunks in files at the storage system 102; associated with embedded chunk vectors substantially similar to the embedded query vector. In certain embodiments, the query manager may comprise query manager 122, the storage system may comprise storage system 104ᵢ, and the embedding module may comprise embedding module 128, as described with respect to FIG. 1.

Upon receiving (at lock 600) the embedded query vector, the query manager determines (at block 602) a geographical distance between the embedded query vector and each of the embedded chunk vectors in the vector database in the vector space. The query manager determines (at block 604) similar embedded chunk vectors whose distance from the embedded query vector is within a distance threshold. Alternatively, the query manager may determine a predetermined number of embedded chunk vectors closest to the embedded query vector in the vector space, i.e., top results. The query manager determines (at block 606) storage locations associated with the similar embedded chunk vectors in the chunk vector entries. The data at the determined storage locations are read (at block 608) from the storage devices to return as search results to the host sending the query.

With the embodiment of operations of FIGS. 5 and 6, the search of embedded vectors is performed with respect to chunks within the file. In this way, the search results are optimized by returning only those chunks or sections of a file that have content descriptions similar to the query terms, as opposed to determining the entire file or sections of a file not relevant to the query. Further, in certain embodiments, by returning the entire chunk content from the file, more robust information is provided than just providing summary content of the data.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

In the flowcharts and description, when there is a condition with different operations described as performed depending on the result of the condition, all results of the condition may occur at different times resulting in the different operations performed for the different results of the condition at different times.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

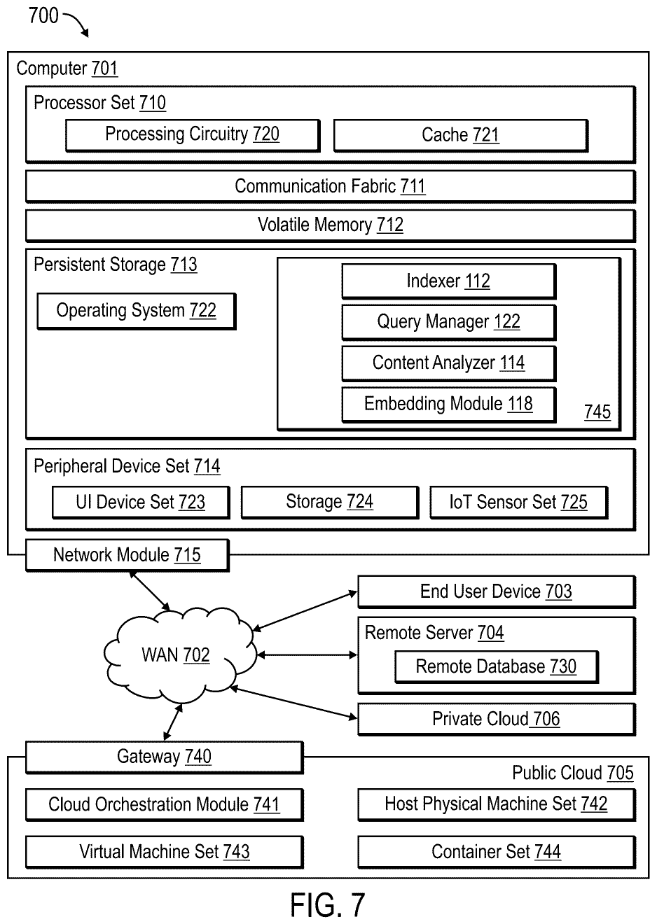

With respect to FIG. 7, computing environment 700 contains an example of an environment for the execution of at least some of the computer code in block 745 involved in performing the inventive methods, such as the operations of the indexer 112, query manager 122, content analyzer 114, and embedding module 118 to populate and use the vector database 200 for searches. In addition to block 745, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 745, as identified above), peripheral device set 714 (including user interface (UI) device set 723, storage 724, and Internet of Things (IOT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer-readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored or implemented in block 745 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 745 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector. The peripheral device set 714 may further include a hardware accelerator in which to implement machine learning modules including the content analyzer 114 and embedding module 118.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer-readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on. The EUD 703 may comprise the host systems 102, including search engine 124 and embedding module 128 as shown in FIG. 1.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

CLOUD COMPUTING SERVICES AND/OR MICROSERVICES (not separately shown in FIG. 7): private and public clouds 706 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i and n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

1. A computer implemented method for providing a vector database for queries for files in a storage, comprising:
processing, by a content analyzer, content within a file to determine content descriptions of the content in the file, wherein the content descriptions comprise descriptions of the content within the file that contextualizes the content in the file that is processed;
determining chunks at storage locations in the file having the content associated with the determined content descriptions;
generating embedded vectors representing the content descriptions of the chunks in a vector space;
storing the embedded vectors associated with the storage locations of the chunks from which the embedded vectors were generated in a vector database, wherein the vector database includes embedded vectors generated from a plurality of files;
processing the vector database to determine embedded vectors similar to a query embedded vector representing a query; and
returning, to the query, chunks at the storage locations associated with the determined embedded vectors.

2. The computer implemented method of claim 1, wherein the returning the chunks comprises:
determining storage locations associated with the determined embedded vectors in the vector database; and
reading chunks of data at the storage locations to return to the query.

3. The computer implemented method of claim 1, wherein the storage locations associated with the chunks comprise ranges of logical block addresses (LBAs) in a storage system.

4. The computer implemented method of claim 1, further comprising:
processing a write including write data to write to a target file;
writing the write data to the target file;
determining updated chunks in the target file including the write data;
processing, by the content analyzer, the updated chunks to generate updated content descriptions of the updated chunks;
generating updated embedded vectors representing the updated content descriptions; and
updating the vector database with the updated embedded vectors for the updated chunks.

5. The computer implemented method of claim 4, wherein the embedded vectors in the vector database are only updated if an updated embedded vector differs from a stored embedded vector for a chunk in the vector database.

6. The computer implemented method of claim 1, wherein the chunks comprise sections of text within the file of variable size and wherein the content descriptions for the chunks comprise topic analysis of text within the chunks.

7. The computer implemented method of claim 1, wherein there are a plurality of vector databases having embedded vectors representing chunks of data in files in storage systems distributed over a network, wherein the processing the vector database to determine embedded vectors similar to the query embedded vector representing the query comprises:
comparing the query embedded vector to embedded vectors in the plurality of vector databases to determine embedded vectors in the vector databases for the storage systems that are similar to the query embedded vector;
for the determined embedded vectors in the vector databases, determine storage locations in the storage systems associated with the vector databases; and
fetching the chunks at the determined storage locations in the storage systems distributed across the network to return to the query.

8. The computer implemented method of claim 1, wherein the determined chunks have different content descriptions, wherein a chunk within the file corresponds to a range of storage locations having content resulting in a different content description from content descriptions for adjacent chunks in the file.

9. A computer program product for providing a vector database for queries for files in a storage, comprising:
one or more computer-readable storage media; and
program instructions stored on the one or more computer-readable storage media to perform operations comprising:
processing, by a content analyzer, content within a file to determine content descriptions of the content in the file, wherein the content descriptions provide descriptions of the content within the file that contextualizes the content in the file that is processed;
determining chunks at storage locations in the file having the content associated with the determined content descriptions;
generating embedded vectors representing the content descriptions of the chunks in a vector space;
storing the embedded vectors associated with the storage locations of the chunks from which the embedded vectors were generated in a vector database, wherein the vector database includes embedded vectors generated from a plurality of files;
processing the vector database to determine embedded vectors similar to a query embedded vector representing a query; and
returning, to the query, chunks at the storage locations associated with the determined embedded vectors.

10. The computer program product of claim 9, wherein the returning the chunks comprises:
determining storage locations associated with the determined embedded vectors in the vector database; and
reading chunks of data at the storage locations to return to the query.

11. The computer program product of claim 9, wherein the operations further comprise:
processing a write including write data to write to a target file;
writing the write data to the target file;
determining updated chunks in the target file including the write data;
processing, by the content analyzer, the updated chunks to generate updated content descriptions of the updated chunks;
generating updated embedded vectors representing the updated content descriptions; and
updating the vector database with the updated embedded vectors for the updated chunks.

12. The computer program product of claim 11, wherein the embedded vectors in the vector database are only updated if an updated embedded vector differs from a stored embedded vector for a chunk in the vector database.

13. The computer program product of claim 9, wherein there are a plurality of vector databases having embedded vectors representing chunks of data in files in storage systems distributed over a network, wherein the processing the vector database to determine embedded vectors similar to the query embedded vector representing the query comprises:
comparing the query embedded vector to embedded vectors in the plurality of vector databases to determine embedded vectors in the vector databases for the storage systems that are similar to the query embedded vector;
for the determined embedded vectors in the vector databases, determine storage locations in the storage systems associated with the vector databases; and
fetching the chunks at the determined storage locations in the storage systems distributed across the network to return to the query.

14. The computer program product of claim 9, wherein the determined chunks have different content descriptions, wherein a chunk within the file corresponds to a range of storage locations having content resulting in a different content description from content descriptions for adjacent chunks in the file.

15. A computer system for providing a vector database for queries for files in a storage, comprising:
a processor set;
one or more computer-readable storage media; and
program instructions stored on the one or more computer-readable storage media to cause the processor set to perform operations comprising:
processing, by a content analyzer, content within a file to determine content descriptions of the content in the file, wherein the content descriptions provide descriptions of the content within the file that contextualizes the content in the file that is processed;
determining chunks at storage locations in the file having the content associated with the determined content descriptions;
generating embedded vectors representing the content descriptions of the chunks in a vector space;
storing the embedded vectors associated with the storage locations of the chunks from which the embedded vectors were generated in a vector database, wherein the vector database includes embedded vectors generated from a plurality of files;
processing the vector database to determine embedded vectors similar to a query embedded vector representing a query; and
returning, to the query, chunks at the storage locations associated with the determined embedded vectors.

16. The computer system of claim 15, wherein the returning the chunks comprises:
determining storage locations associated with the determined embedded vectors in the vector database; and
reading chunks of data at the storage locations to return to the query.

17. The computer system of claim 15, wherein the operations further comprise:
processing a write including write data to write to a target file;
writing the write data to the target file;
determining updated chunks in the target file including the write data;
processing, by the content analyzer, the updated chunks to generate updated content descriptions of the updated chunks;
generating updated embedded vectors representing the updated content descriptions; and
updating the vector database with the updated embedded vectors for the updated chunks.

18. The computer system of claim 17, wherein the embedded vectors in the vector database are only updated if an updated embedded vector differs from a stored embedded vector for a chunk in the vector database.

19. The computer system of claim 15, wherein there are a plurality of vector databases having embedded vectors representing chunks of data in files in storage systems distributed over a network, wherein the processing the vector database to determine embedded vectors similar to the query embedded vector representing the query comprises:
comparing the query embedded vector to embedded vectors in the plurality of vector databases to determine embedded vectors in the vector databases for the storage systems that are similar to the query embedded vector;
for the determined embedded vectors in the vector databases, determine storage locations in the storage systems associated with the vector databases; and
fetching the chunks at the determined storage locations in the storage systems distributed across the network to return to the query.

20. The computer system of claim 15, wherein the determined chunks have different content descriptions, wherein a chunk within the file corresponds to a range of storage locations having content resulting in a different content description from content descriptions for adjacent chunks in the file.
